(19) United States
(12) Patent Application Publication
(10) Pub. No.: US 2020/0122669 A1
(43) Pub. Date: Apr. 23, 2020

(54) Self-rescue device for automatically driving a door when a car is drowning

(71) Applicant: Liping Yao, Wenzhou City (CN)

(72) Inventor: Liping Yao, Wenzhou City (CN)

(21) Appl. No.: 16/724,382

(22) Filed: Dec. 23, 2019

(30) Foreign Application Priority Data
Oct. 11, 2019 (CN) 2019109651299

(51) Int. Cl. B60R 21/20; B60J 5/04; F16H 1/20; B63C 9/00; B25D 17/28

(52) U.S. Cl. CPC B60R 21/20; B60J 5/0468; B25D 2250/271; B63C 9/00; B25D 17/28; F16H 1/203

(57) ABSTRACT

The invention discloses a self-rescue device for an automatic driving door when a car is drowning. It includes a first body, a hollow slider is threadedly installed on the threaded screw, and the first rotation shaft is located in the first sliding space to rotate and install a first A universal joint, the other side of the first universal joint is rotationally connected to the right-hand threaded screw, and a motor is used to drive and control the three-position threaded screw to adjust the position of the safety hammer. Save time in time, and the edge of the glass is the easiest to break, so it can be extended to the edge of the glass in a short period of time, greatly increasing the chance of survival, and a life buoy is stored in the middle, which can be used in a short time in an emergency Time to quickly inflate the lifebuoy to give people who can't swim a little vitality.

### CROSS-REFERENCES TO RELATED APPLICATIONS

The present application claims priority from Chinese application No. 2019109651299 filed on Oct. 11, 2019 which is hereby incorporated by reference in its entirety.

### TECHNICAL FIELD

The invention relates to the field of safety self-rescue, in particular to a self-rescue device for automatically driving a door when a car is drowning.

### BACKGROUND OF THE INVENTION

There are endless types of car accidents. Drowning in cars is also a type of accident. Drowning in cars often results in drowning and drowning because of being imprisoned in the car. Even if the car is in the water, the water pressure causes It is difficult to open the car door normally. In the face of the rising water level in the car and the car door cannot be opened, we need to calm down and find ways to escape. We can use abnormal means to break a part of the car and exchange for property damage. Back to life safety, therefore, it is necessary to invent the above problems.

### BRIEF SUMMARY OF THE INVENTION

The purpose of the present invention is to provide a self-rescue device for automatically opening a door when a car drowns, which is used to overcome the above-mentioned defects in the prior art.

According to an embodiment of the present invention, a self-rescue device for an automatic driving door when a car is drowning includes a first body, an extension space is provided on the right side of the first body, and an extension space is provided in the extension space for extending to the edge of the glass. An extension member to be blasted, the extension member includes three threaded screws installed in the extension space in a center symmetrical rotation, a hollow slider is threadedly installed on the threaded screw, and the three hollow sliders are fixedly installed at the center point A third sliding base, a third sliding track is provided in the third sliding base, and a third sliding rod is slidably installed in the third sliding base, and the third sliding rod is fixedly connected to the front side of the hollow slider. A safety hammer is fixedly installed on the front side of the hollow slider, and when the threaded screw rotates to drive the hollow slider to move to the edge of the glass, the forward and backward movement of the hollow slider drives the safety hammer to strike the glass back and forth.

A self-rescue space is connected to the rear side of the extension space, and a self-rescue part for temporarily inflating self-rescue is provided in the self-rescue space. The self-rescue part includes a life buoy fixedly installed on the right wall of the self-rescue space. Take it out during blasting and fill it with gas to form a life buoy for self-rescue.

On the basis of the above technical solution, the extension member further includes a second body slidingly installed in the right wall of the extension space, and a first transmission space is provided in the second body, and the first transmission space is right A motor is fixedly installed in the wall, a first rotating shaft is fixedly installed on the motor output shaft, and a first sliding space communicating with the extension space is provided on the left side of the first transmission space, and the first rotating shaft is located in the first A first universal joint is rotatably installed in a sliding space, and the other side of the first universal joint is rotatably connected with the right-hand threaded screw.

Based on the above technical solution, a first sliding base is rotatably installed between the left wall of the first transmission space and the right wall of the extension space, and the right side of the first sliding base is fixedly installed in the first transmission space of So Sohu A second gear, the second gear meshing with the first gear, a first slideway is provided in the first sliding base, a second transmission space is provided in the first body, and the second transmission A first sliding rod is rotatably installed between the right wall of the space and the left wall of the extension space, the first sliding rod can slide in the first slideway, and a third gear is fixedly installed on the left side of the first sliding rod. A second sliding space communicating with the extension space is provided in the right wall of the second transmission space, and a space between the right wall of the second transmission space and the left wall of the second sliding space is located under the first sliding rod. A second rotation shaft is installed on the side, a fourth gear is fixedly installed in the second transmission space on the second rotation shaft, the fourth gear is meshed with the third gear, and the second rotation shaft is located on the second rotation shaft. Rotating installation in the second sliding space Twenty thousand to the section, the other side of the second joint of the left threaded screw rotatably mounted.

Based on the above technical solution, a third transmission space is provided below the second transmission space, and a rotation shaft is rotatably installed between the bottom wall of the second transmission space and the top wall of the third transmission space. A second helical gear is fixedly installed on the upper side, a first helical gear is fixedly installed on the left side of the second rotating shaft, the first helical gear meshes with the second helical gear, and a third is fixedly installed on the lower side of the rotating shaft. Helical gear, a second sliding base is rotatably installed between the right wall of the third transmission space and the left wall of the extension space, the second sliding base is provided with a second slideway, and the left side of the second sliding base is fixed A fourth helical gear is installed, the third helical gear meshes with the third helical gear, a fourth transmission space is provided in the bottom wall of the second fuselage, and the left wall of the fourth transmission space and the extension space A second slide bar is rotatably installed between the right walls, the second slide bar is slidably connected to the second slide base, and a spring is fixedly installed between the left side surface of the second slide bar and the left wall of the second slideway. The right side of the second sliding rod is fixedly installed Five helical gear, said sixth bevel gear fixedly mounted under the upper side of the lower side of the threaded screw, said sixth bevel gear meshing with said fifth bevel gear.

Based on the above technical solution, a hydraulic cylinder is fixedly installed on the right wall of the self-rescue space, and a telescopic rod is fixedly installed on the piston of the hydraulic cylinder. The telescopic rod extends into the extension space, and the telescopic rod and the first The three sliding bases are fixedly connected, the left and right symmetric hinges of the hollow slider are connected to the connecting rod, the left link is hinged to the fourth sliding rod, the right side of the hollow slider is connected to the fourth sliding base, and the fourth sliding A fourth slideway is provided in the base, and the fourth slide bar is slidably connected to the fourth slideway.

Based on the above technical solution, the self-rescue component further includes an air suction pump fixedly installed in the right wall of the extension space, and a right side of the air suction pump is provided with a pipe communicating with the right side of the second fuselage. The pipeline is fixedly connected to the input port of the air pump, an air pipe is fixedly connected to the lifebuoy inflation port, and the other side of the air pipe is fixedly connected to the air pump output port.

The beneficial effect of the present invention is that the present invention uses a motor to drive and control three positions of the threaded screw to adjust the position of the hammer. Therefore, it can be extended to knock on the edge of the glass in a short period of time, greatly increasing the chance of survival, and a life buoy is stored in the middle, which can quickly inflate the buoy in a short time in an emergency, giving people who cannot swim to the front line Lively, worthy of promotion.

### BRIEF DESCRIPTION OF THE DRAWINGS

In order to more clearly explain the embodiments of the present invention or the technical solutions in the prior art, the drawings used in the embodiments will be briefly introduced below. Obviously, the drawings in the following description are only some of the present invention. For those of ordinary skill in the art, other embodiments may be obtained based on these drawings without paying creative effort.

FIG. 1 is a schematic diagram of the overall structure of the present invention;

FIG. 2 is a left side view of FIG. 1 of the present invention;

FIG. 3 is a partially enlarged view of A in FIG. 1 of the present invention.

### DETAILED DESCRIPTION OF THE INVENTION

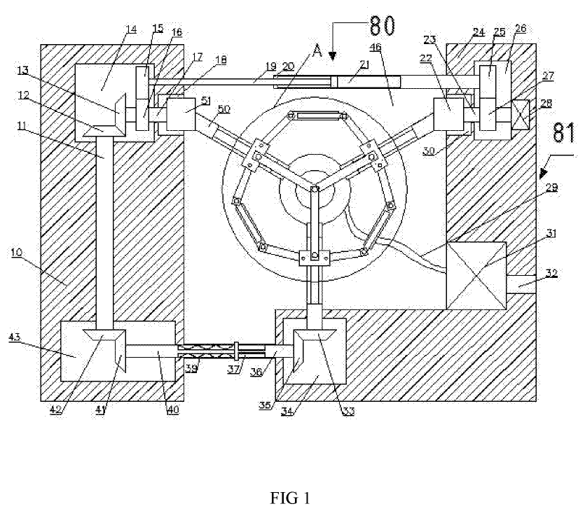

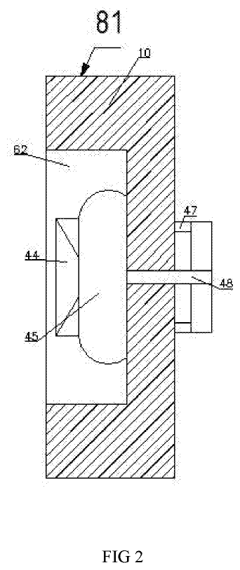

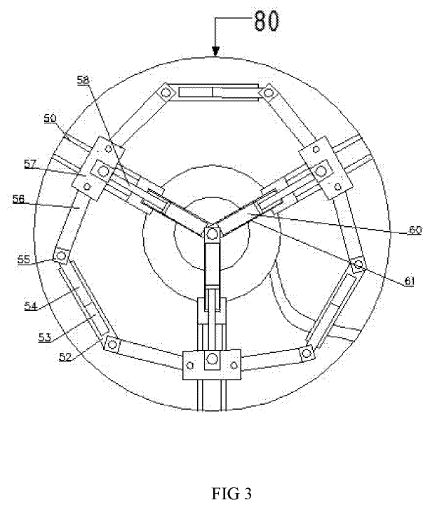

The present invention will be described in detail below with reference to FIGS. 1-3. Among them, for convenience of description, the orientation described below is defined as follows: the up-down, left-right, left-back, and up-down directions described below are consistent with the front-back, left-right, up, down, and down directions of the view in FIG. 1 is a front view of the device of the present invention, and the direction shown in FIG. 1 is the same as the front, rear, left, right, and up and down directions of the device of the present invention.

1-3, according to an embodiment of the present invention, a self-rescue device for automatically driving a door when a vehicle is drowning includes a first body 10, and an extension space 46 is provided on the right side of the first body 10, and the extension An extension member for extending to the edge of the glass to be blasted is provided in the space 46. The extension member includes three threaded screws 50 which are installed in the extension space 46 and rotate symmetrically in the center. A hollow slider is threadedly installed on the threaded screw 50. 57. A third sliding base 61 is fixedly installed at the center point of the three hollow sliders 57. A third slide 60 is provided in the third sliding base 61, and a third slide is installed in the third slide 60. A rod 58, the third sliding rod 58 is fixedly connected to the front side of the hollow slider 57, a safety hammer is fixedly installed on the front side of the hollow slider 57, and the threaded screw 50 rotates to drive the hollow slider 57 to move When it reaches the edge of the glass, the hollow slider 57 moves forward and backward to drive the safety hammer back and forth to break the glass.

A self-rescue space 62 is connected to the rear side of the extension space 46, and a self-rescue part for temporary inflatable self-rescue is provided in the self-rescue space 62. The self-rescue part includes a life buoy 45 fixedly installed on the right wall of the self-rescue space 62. The life buoy 45 can be taken out during blasting and filled with gas to form a life buoy for self-rescue.

In addition, in one embodiment, the extension member further includes a second body 24 slidably installed in the right wall of the extension space 46, and a first transmission space 26 is provided in the second body 24. A motor 28 is fixedly installed in the right wall of the first transmission space 26, and a first rotating shaft 23 is fixedly mounted on the output shaft of the motor 28. A first sliding space is provided on the left side of the first transmission space 26 and communicates with the extension space 46 30. The first rotating shaft 23 is located in the first sliding space 30 to rotate and install a first universal joint 22, and the other side of the first universal joint 22 is rotatably connected to the right threaded screw 50. When the right hollow slider 57 is extended, the motor 28 is started, the motor 28 drives the first rotating shaft 23 to rotate, the first rotating shaft 23 drives the right threaded screw 50 to rotate, and the threaded screw 50 drives the right hollow slider 57 to slide to the right. The extension of the right hollow slider 57 is completed.

In addition, in an embodiment, a first sliding base 20 is rotatably installed between a left wall of the first transmission space 26 and a right wall of the extension space 46, and a right side surface of the first sliding base 20 is located in the first A second gear 25 is fixedly installed in the transmission space 26. The second gear 25 meshes with the first gear 27. A first slide rail 21 is provided in the first sliding base 20. A second transmission space 14 is provided. A first sliding rod 19 is rotatably installed between the right wall of the second transmission space 14 and the left wall of the extension space 46, and the first sliding rod 19 can be mounted on the first slideway. 21, the third gear 15 is fixedly installed on the left side of the first sliding rod 19, and the second transmission space 14 is provided with a second sliding space 18 communicating with the extension space 46 in the right wall. Between the right wall of the two transmission spaces 14 and the left wall of the second sliding space 18, a second rotating shaft 17 is rotatably installed under the first sliding rod 19 of Su Sohu, and the second rotating shaft 17 is located on the second transmission A fourth gear 16 is fixedly installed in the space 14, and the fourth gear 16 meshes with the third gear 15. A second universal joint 51 is rotatably mounted on the two rotation shafts 17 in the second sliding space 18, and the left side screw 50 and the left hollow slider 57 are rotatably mounted on the other side of the second universal joint 51 When it needs to be extended, the first rotating shaft 23 drives the first gear 27 to rotate, the first gear 27 drives the second gear 25 to rotate, the second gear 25 drives the first sliding base 20 to rotate, and the first sliding base 20 drives the first sliding rod 19 Rotating, the first sliding rod 19 drives the third gear 15 to rotate, the third gear 15 drives the fourth gear 16 to rotate, the fourth gear 16 drives the second rotating shaft 17 to rotate, and the second rotating shaft 17 drives the left threaded screw 50 to rotate, The left-hand threaded screw 50 rotates to drive the left-side hollow slider 57 to slide to the left to complete the extension of the left-side hollow slider 57.

In addition, in an embodiment, a third transmission space 43 is provided below the second transmission space 14, and a rotation shaft is rotatably installed between a bottom wall of the second transmission space 14 and a top wall of the third transmission space 43. 11, a second helical gear 12 is fixedly installed on the upper side of the rotating shaft 11, a first helical gear 13 is fixedly installed on the left side of the second rotating shaft 17, the first helical gear 13 and the second helical gear 12 Meshing, a third helical gear 42 is fixedly installed on the lower side of the rotating shaft 11, and a second sliding base 40 is rotatably installed between the right wall of the third transmission space 43 and the left wall of the extension space 46, and the second sliding base 40 is provided with a second slideway 37, a fourth helical gear 41 is fixedly installed on the left side of the second sliding base 40, the third helical gear 42 meshes with the third helical gear 42, and the second body A fourth transmission space 34 is provided in the bottom wall, and a second sliding rod 36 is rotatably installed between the left wall of the fourth transmission space 34 and the right wall of the extension space 46. Two sliding bases 40 are slidably connected, between the left side of the second sliding rod 36 and the left wall of the second sliding track 37 A fixed mounting spring 39, a fifth helical gear 35 is fixedly installed on the right side of the second sliding rod 36, and a sixth helical gear 33 is fixedly installed on the lower side of the lower threaded screw 50; When the fifth helical gear 35 is engaged, and when the lower hollow slider 57 is to be extended, the second rotating shaft 17 rotates to drive the first helical gear 13 to rotate, the first helical gear 13 drives the second helical gear 12 to rotate, and the second helical gear 12 Drive the rotating shaft 11 to rotate, the rotating shaft 11 drives the third bevel gear 42 to rotate, the third bevel gear 42 drives the fourth bevel gear 41 to rotate, the fourth bevel gear 41 drives the second sliding base 40 to rotate, and the second sliding base 40 drives the first The two sliding rods 36 rotate, the second sliding rod 36 drives the fifth helical gear 35, the fifth helical gear 35 drives the sixth helical gear 33, and the sixth helical gear 33 drives the lower threaded screw 50, and the lower threaded screw 50 The lower hollow slider 57 is driven to move downward to complete the extension of the lower hollow slider 57.

In addition, in one embodiment, a hydraulic cylinder 44 is fixedly installed on the right wall of the self-rescue space 62, and a telescopic rod 48 is fixedly installed on the piston of the hydraulic cylinder 44. The telescopic rod 48 extends into the extension space 46. The telescopic rod 48 is fixedly connected to the third sliding base 61, the hollow slider 57 is hinged to the left and right symmetrically connected to the link 56, the left link 56 is hinged to the fourth sliding rod 54, and the hollow slider 57 The right hinge is connected to the fourth sliding base 52. The fourth sliding base 52 is provided with a fourth slideway 53. The fourth slide bar 54 is slidingly connected to the fourth slideway 53. When the glass is to be tapped, Start the hydraulic cylinder 44, the hydraulic cylinder 44 drives the telescopic rod 48 to move forward and backward, the telescopic rod 48 drives the third sliding base 61 to move forward and backward, the third sliding base 61 drives the third sliding rod 58 to move forward and backward, and the third sliding rod 58 drives the hollow slider 57 moves forward and backward, the hollow slider 57 drives the safety hammer forward and backward to break the glass.

In addition, in one embodiment, the self-rescue component further includes an air suction pump 31 fixedly installed in the right wall of the extension space 46. A right side of the air suction pump 31 is provided with a right side surface of the second body 24. A communication pipe 32, which is fixedly connected to the input port of the suction pump 31, a gas pipe 29 is fixedly connected to the inflation port of the life buoy 45, and the other side of the gas pipe 29 is fixedly connected to the output port of the suction pump 31, When self-rescue is needed, the air pump 31 is started, and the air pump 31 fills the air into the life buoy 45 through the air pipe 29. After the inflation, the self-rescue can be performed.

Initially: the hollow slider 57 slides to the most center position of the threaded screw 50, the first slide rod 19 slides to contact the right wall of the first slideway 21, and the second slide base 40 slides to contact The right wall of the second slideway 37, and the lifebuoy 45 is in a pinhole vacuum state;

When used: When the glass needs to be broken, when the right hollow slider 57 needs to be extended, the motor 28 is started, the motor 28 drives the first rotating shaft 23 to rotate, the first rotating shaft 23 drives the right threaded screw 50 to rotate, and the threaded screw 50 to drive The right hollow slider 57 slides to the right to complete the extension of the right hollow slider 57. When the left hollow slider 57 needs to be extended, the first rotating shaft 23 drives the first gear 27 to rotate, and the first gear 27 drives the second gear 25 turns, the second gear 25 drives the first sliding base 20 to rotate, the first sliding base 20 drives the first sliding rod 19 to rotate, the first sliding rod 19 drives the third gear 15 to rotate, and the third gear 15 drives the fourth gear 16 to rotate The fourth gear 16 drives the second rotating shaft 17 to rotate. The second rotating shaft 17 drives the left threaded screw 50 to rotate, and the left threaded screw 50 rotates to drive the left hollow slider 57 to slide to the left to complete the left hollow slider 57. When the lower hollow slider 57 is extended, the second rotating shaft 17 rotates to drive the first helical gear 13 to rotate, the first helical gear 13 drives the second helical gear 12 to rotate, and the second helical gear 12 drives the rotating shaft 11 to rotate, Rotating the shaft 11 to drive the first The helical gear 42 rotates, the third helical gear 42 drives the fourth helical gear 41, the fourth helical gear 41 drives the second sliding base 40, the second sliding base 40 drives the second sliding rod 36, and the second sliding rod 36 drives The fifth helical gear 35 rotates, the fifth helical gear 35 drives the sixth helical gear 33 to rotate, the sixth helical gear 33 drives the lower threaded screw 50 to rotate, and the lower threaded screw 50 drives the lower hollow slider 57 to move downward to complete The extension of the lower hollow slider 57. When the glass is to be tapped, the hydraulic cylinder 44 is activated, the hydraulic cylinder 44 drives the telescopic rod 48 to move forward and backward, the telescopic rod 48 drives the third sliding base 61 to move forward and backward, and the third sliding base 61 drives the third The sliding rod 58 moves forward and backward. The third sliding rod 58 drives the hollow slider 57 to move forward and backward. The hollow slider 57 drives the safety hammer to move forward and backward to break the glass.

When self-rescue is needed, the air pump 31 is started, and the air pump 31 fills the air into the life buoy 45 through the air pipe 29. After the inflation, the self-rescue can be performed.

The beneficial effect of the present invention is that the present invention uses a motor to drive and control three positions of the threaded screw to adjust the position of the hammer. Therefore, it can be extended to knock on the edge of the glass in a short period of time, greatly increasing the chance of survival, and a life buoy is stored in the middle, which can quickly inflate the buoy in a short time in an emergency, giving people who cannot swim to the front line Lively, worthy of promotion.

Those skilled in the art can clearly understand that various modifications to the above embodiments can be made without departing from the overall spirit and concept of the present invention. They all fall within the protection scope of the present invention. The protection scheme of the present invention is subject to the claims attached to the present invention.

1. A self-rescue device for an automatic driving door when a car is drowning, comprising a first fuselage, characterized in that: an extension space is provided on the right side of the first fuselage, and an extension space is provided for preparing to extend to the edge of the glass A blasting extension member includes three threaded screws installed in the extension space symmetrically and rotatably on the threaded screw, and a hollow slider is threadedly installed on the threaded screw. Three sliding bases, a third sliding base is provided in the third sliding base, a third sliding rod is slidably installed in the third sliding base, the third sliding rod is fixedly connected to the front side of the hollow slider, and A safety hammer is fixedly installed on the front side of the hollow slider, and when the threaded screw rotates to drive the hollow slider to the edge of the glass, the forward and backward movement of the hollow slider drives the safety hammer to strike the glass back and forth, breaking the glass,
a self-rescue space is connected to the rear side of the extension space, and a self-rescue part for temporarily inflating self-rescue is provided in the self-rescue space. The self-rescue part includes a life buoy fixedly installed on the right wall of the self-rescue space. Take it out during blasting and fill it with gas to form a life buoy for self-rescue.

2. A self-rescue device for an automatic driving door when a car is drowning according to claim 1, wherein the extension member further comprises a second body slidingly installed in the right wall of the extension space, and the first A first transmission space is provided in the two bodies, and a motor is fixedly installed in the right wall of the first transmission space. A first rotating shaft is fixedly installed on the output shaft of the motor. A first sliding space in the extension space, the first rotating shaft is located in the first sliding space, and a first universal joint is rotatably installed, and the other side of the first universal joint is rotatably connected with the right-hand threaded screw.

3. A self-rescue device for an automatic driving door when a car is drowning according to claim 1, wherein a first sliding base is rotatably installed between a left wall of the first transmission space and a right wall of the extension space, A right side surface of the first sliding base is fixedly installed with a second gear in the first transmission space, the second gear meshes with the first gear, and a first slide rail is provided in the first sliding base. A second transmission space is provided in the first body, and a first sliding rod is rotatably installed between the right wall of the second transmission space and the left wall of the extension space. Sliding in the road, a third gear is fixedly installed on the left side of the first sliding rod, and a second sliding space communicating with the extension space is provided in the right wall of the second transmission space, and the right wall of the second transmission space and A second rotating shaft is rotatably installed between the left wall of the second sliding space and the lower side of the Sosohu first sliding rod, and a fourth gear is fixedly installed in the second transmission space on the second rotating shaft. Four gears mesh with the third gear, A second universal joint is rotatably mounted on the second rotating shaft in the second sliding space, and the left side screw is rotatably mounted on the other side of the second universal joint.

4. A self-rescue device for an automatic driving door when a car is drowned according to claim 1, wherein a third transmission space is provided below the second transmission space, and a bottom wall of the second transmission space and A rotation shaft is rotatably installed between the top walls of the third transmission space, a second helical gear is fixedly installed on the upper side of the rotation shaft, and a first helical gear is fixedly installed on the left side of the second rotation shaft. The second helical gear meshes, a third helical gear is fixedly installed on the lower side of the rotation shaft, and a second sliding base is rotatably installed between the right wall of the third transmission space and the left wall of the extension space, and the second sliding The base is provided with a second slideway, and a fourth helical gear is fixedly installed on the left side of the second slide base. The third helical gear meshes with the third helical gear. A fourth transmission space, and a second sliding rod is rotatably installed between the left wall of the fourth transmission space and the right wall of the extension space, the second sliding rod is slidably connected to the second sliding base, and the second sliding The left side of the rod and the left wall of the second slideway A spring is fixedly installed between the fifth sliding gear on the right side of the second sliding rod, a sixth helical gear is fixed on the lower side of the lower threaded screw, and the sixth helical gear and the fifth helical gear Gears mesh.

5. A self-rescue device for automatically driving a door when a car is drowned according to claim 1, characterized in that: a hydraulic cylinder is fixedly installed on the right wall of the self-rescue space, and a telescopic rod is fixedly installed on the hydraulic cylinder piston, A telescopic rod extends into the extension space, the telescopic rod is fixedly connected to the third sliding base, the hollow slider is connected to the left and right symmetrical hinges, and the left link is hinged to the fourth sliding rod. The right side hinge of the hollow slider is connected to a fourth sliding base, a fourth sliding track is arranged in the fourth sliding base, and the fourth sliding rod is slidingly connected to the fourth sliding track.

6. A self-rescue device for automatically driving a door when a car is drowning according to claim 1, wherein the self-rescue component further comprises an air suction pump fixedly installed in the right wall of the extension space, A duct is connected to the right side of the second body, the duct is fixedly connected to the inlet of the air pump, a gas pipe is fixedly connected to the lifebuoy inflation port, and the other side of the gas pipe is connected to the air pump. The air pump output is fixedly connected.
